(19) United States
(12) Patent Application Publication
(10) Pub. No.: US 2023/0157217 A1
(43) Pub. Date: May 25, 2023

(54) HEURISTIC PLANT PRODUCTION SYSTEMS, METHODS, AND ASSOCIATED DEVICES

(71) Applicant: AGxano Inc., Las Vegas, NV (US)

(72) Inventors: James Ryan Doyle, Laguna Niguel, CA (US); Roger Cheek, Las Vegas, NV (US); James Scott Doyle, San Juan Capistrano, CA (US)

(73) Assignee: AGxano Inc., Las Vegas, NV (US)

(21) Appl. No.: 17/971,059

(22) Filed: Oct. 21, 2022

Related U.S. Application Data
(60) Provisional application No. 63/270,809, filed on Oct. 22, 2021.

(51) Int. Cl. A01G 7/04; H05B 45/12; H05B 45/20

(52) U.S. Cl. CPC A01G 7/045; H05B 45/12; H05B 45/20

(57) ABSTRACT

An advanced plant production system comprises a robust and efficient network of lighting, instrumentation and control and data acquisition systems, which are integrated together to maximize plant health, crop production, while conserving resources. The system provides an advanced user interface that can be accessed both locally and remotely. In some embodiments, the lighting can be controlled to mimic the circadian rhythm of the crops or the Sun, and can be matched to a particular type and/or maturity of plant. A sensor node which can be used in the plant production system comprises internal sensors, and can also be connected to other external sensors, to provide detailed environmental information. Several methods are described that can optimize the efficiency of the system, and can be used to improve the yield, value, and/or quality of crops.

### RELATED APPLICATIONS

This Application is a Non-Provisional of Provisional (35 USC 119(e)) of U.S. Application Ser. No. 63/270,809, filed Oct. 22, 2021, entitled “HEURISTIC PLANT PRODUCTION SYSTEMS, METHODS, AND ASSOCIATED DEVICES”, which is hereby incorporated by reference in its entirety.

### FIELD

Aspects described herein relate generally to a system and related components, methods and user interfaces for indoor plant growing environments.

### BACKGROUND

In nature, plants grow in response to their environment, such as based on time of day, available light, moisture, temperature, nutrients, relative humidity, wind, and other environmental factors. Plants are typically synchronized with a circadian rhythm, which is repeated on roughly a daily basis, and which changes as the plant grows and matures.

Sheltered growing environments, such as grow rooms and greenhouses, have previously been used for a variety of horticultural applications. In a grow room, powered light sources are controlled to provide light energy for growing crops, such as for any of starting seedlings, raising seedlings for eventual transfer, and/or for raising crops until harvest, e.g., from seed or seedlings. While lights may typically be controlled in grow rooms to emulate periods of daylight and darkness, the lighting controls are typically set or changed by the grower, such as to be simply powered on or off at selected setpoints.

The specific needs of different crops can also be varied, in terms of soil, water, lighting, temperature, time to harvest, etc.

The cost to grow crops in such an environment is based on several factors, including the developed property, labor, lighting, water, environmental controls, sensors and general monitoring. The largest factors in the cost of indoor cultivation are the lighting, lighting controls, and energy. In many areas, the capital expenditure and cost of energy are often prohibitive.

### BRIEF SUMMARY

An advanced plant production system is described herein, which can include several advanced systems, components, and methods to increase the efficiency, yield, and quality of plants in a controlled growing environment.

An exemplary method for growing plants comprises controlling the operation of a lighting system on a lighting schedule to mimic a circadian rhythm for cultivation of a plant and, based on results of a prior harvest for a similar plant, modifying operation of the lighting system to change the circadian rhythm for the cultivation of the plant.

An exemplary lighting system comprises a lighting fixture having a controllable output intensity, and a driver connected to the lighting system, for operating the lighting fixture on a lighting schedule to mimic a circadian rhythm for cultivation of a plant, and for modifying operation of the lighting fixture to change the circadian rhythm for the cultivation of the plant, based on results of a prior harvest for a similar plant.

An exemplary heuristic plant production method comprises inputting information associated with a plant to be grown in an indoor grow room, inputting information regarding the indoor grow room, growing the plant within the grow room, using a lighting system that includes a lighting fixture having a controllable output intensity, and a driver connected to the lighting system, operating the lighting fixture on a lighting schedule to mimic a circadian rhythm for cultivation of the plant, tracking operation of the lighting system throughout the cultivation of the plant, tracking one or more environmental factors associated with the grow room throughout the cultivation of the plant, at the end of the cultivation, harvesting the plant, determining one or more performance factors associated with the harvested plant, and applying the determined more performance factors to modify the cultivation of subsequent plants.

An exemplary sensor hub comprises an enclosure, a processor having an associated memory within the enclosure, a power source linked to the processor, circuitry for transmitting information from the processor to an external device, a sensor located within the enclosure for monitoring environmental data, wherein the sensor is connected to the processor for storing the environmental data within the memory, and a port connected to the processor for receiving information from an external sensor.

An exemplary method for establishing locations of light fixtures within a facility comprises applying a machine-readable unique identifier to each of a plurality of light fixtures, scanning the machine-readable unique identifier to each of a plurality of light fixtures to identify each of the light fixtures, establishing the location of each of the light fixtures with regard to a site layout, and assigning the identity and location of each of the light fixtures within the facility, wherein the location and attributes of each of the light fixtures is established for the site layout within the facility.

An exemplary method for verifying locations of light fixtures within a pattern comprises powering on each of the light fixtures, one light fixture at a time, during the powering, verifying that the pattern of powered lights runs as expected, for any light in the pattern of light fixtures that does not power as expected, selecting the light fixture that was intended to be powered, and the light fixture that did turn on, and upon completion of the verification, updating the lighting algorithm as needed, to properly attribute the intended location of each of the light fixtures in the pattern with the actual location of the light fixtures.

According to one aspect, a method for growing plants is provided. The method comprises controlling operation of a lighting system on a lighting schedule to mimic a circadian rhythm for cultivation of one or more first plants, gathering results of a harvest of the one or more first plants, and based on the results of the harvest of the one or more first plants, modifying operation of the lighting system to change the circadian rhythm for the cultivation of one or more second plants, wherein the one or more second plants are similar to the one or more first plants. According to one embodiment, the lighting system comprises a light emitting diode (LED) light system. According to one embodiment, the LED light system includes colored LEDs. According to one embodiment, the LED light system includes white LEDs. According to one embodiment, the lighting system includes a light system driver. According to one embodiment, the light system driver is DALI-2 compliant. According to one embodiment, the circadian rhythm is matched to the Sun. According to one embodiment, the circadian rhythm is matched to the plant. According to one embodiment, the method further comprises: modifying a light spectrum of the lighting system. According to one embodiment, modifying of the light spectrum includes modifying the light spectrum during the morning of the light schedule. According to one embodiment, modifying the light spectrum includes adding more reds to the light spectrum in the morning. According to one embodiment, modifying of the light spectrum includes modifying the light spectrum in the evening of the light schedule. According to one embodiment, modifying the light spectrum includes adding more blues to the light spectrum in the evening. According to one embodiment, the lighting system comprises one or more light fixtures and one or more light sensors, the method further comprising: using at least one of the light sensors to measure the amount of light emitted from at least one of the light fixtures, and adjusting the brightness of the at least one light fixture based on the measured light to meet a desired intensity. According to one embodiment, the method further comprises using the at least one light sensor to physically verify that the lighting system is turned on at a predetermined time. According to one embodiment, the lighting system comprises one or more light fixtures and one or more light sensors in a greenhouse, the method further comprising: using at least one of the light sensors in a greenhouse to measure an amount of light received by at least one of the one or more first plants or the one or more second plants from sunlight, and adjusting an intensity of the lighting system, based on the measured light, to meet a predetermined amount of light. According to one embodiment, the method further comprises wirelessly controlling the lighting system to adjust an intensity of light emitted by the lighting system, as at least one of the one or more first plants or the one or more second plants grows taller, to maintain a constant amount of light at a canopy of the at least one plant.

According to one aspect a lighting system is provided. The system comprises, a lighting fixture having a controllable output intensity and a driver connected to the lighting fixture configured to operate the lighting fixture on a lighting schedule to mimic a circadian rhythm for cultivation of a plant, and further configured to modify operation of the lighting fixture to change the circadian rhythm for the cultivation of the plant, based on results of a prior harvest for a similar plant. According to one embodiment, the lighting fixture comprises a light emitting diode (LED) light fixture. According to one embodiment, the LED light fixture includes colored LEDs. According to one embodiment, the LED light fixture includes white LEDs. According to one embodiment, the driver is DALI-2 compliant. According to one embodiment, the circadian rhythm is matched to the Sun. According to one embodiment, the circadian rhythm is matched to the plant.

According to one aspect a heuristic plant production method is provided. The method comprises inputting information associated with a plant to be grown in an indoor grow room, inputting information regarding the indoor grow room, growing the plant within the grow room, using a lighting system that includes: a lighting fixture having a controllable output intensity, and a driver connected to the lighting system, operating the lighting fixture on a lighting schedule to mimic a circadian rhythm for cultivation of the plant, tracking operation of the lighting system throughout the cultivation of the plant, tracking one or more environmental factors associated with the grow room throughout the cultivation of the plant, at the end of the cultivation, harvesting the plant, determining one or more performance factors associated with the harvested plant and applying the determined performance factors to modify the cultivation of a subsequent plant. According to one embodiment, the method further comprises modifying operation of the lighting fixture to change the circadian rhythm for the cultivation of the plant, based on results of a prior harvest for a similar plant. According to one embodiment, the method further comprises modifying a light spectrum of the lighting system. According to one embodiment, modifying of the light spectrum includes modifying the light spectrum during the morning of the light schedule. According to one embodiment, modifying the light spectrum includes adding more reds to the light spectrum in the morning. According to one embodiment, modifying of the light spectrum includes modifying the light spectrum in the evening of the light schedule. According to one embodiment, modifying the light spectrum includes adding more blues to the light spectrum in the evening. According to one embodiment, the method further comprises wirelessly controlling the light system to adjust an intensity of the light, as the plant grows taller, to maintain a constant amount of light at a canopy of the plant. According to one embodiment, the input information associated with a plant comprises any of plant species, plant variety, plant seed lot, and recipe information associated with cultivation of the plant. According to one embodiment, the tracked environmental factors comprise any of temperatures, fertigation information, air flow, maintenance information, carbon dioxide levels, relative humidity, ambient light, vapor pressure deficit information, and alarm log data.

According to one aspect a sensor hub is provided. The sensor hub comprises an enclosure, a processor having an associated memory within the enclosure, a power source linked to the processor, circuitry for transmitting information from the processor to an external system, a sensor located within the enclosure for monitoring environmental data, wherein the sensor is connected to the processor for storing the environmental data within the memory; and a port connected to the processor for receiving information from an external sensor. According to one embodiment, the enclosure provides protection for internal components when installed within a grow room environment. According to one embodiment, the sensor located within the enclosure comprises any of a temperature sensor, a CO2 sensor, and IR sensor, a relative humidity sensor, an accelerometer, an atmospheric pressure sensor, a window/door open/close sensor, and an occupancy/motion sensor. According to one embodiment, the sensor hub further comprises a radio circuitry linked to the processor. According to one embodiment, the processor can wirelessly transmit sensor data to an external device through the radio circuitry. According to one embodiment, the sensor hub further comprises a user interface for any of determining battery status, determining connection status, resetting the sensor hub to initiate a factory reset, and powering the sensor hub, troubleshooting, downloading data, and calibration. According to one embodiment, the sensor hub can be connected wirelessly to other sensor hubs within a mesh network.

According to one aspect a method for establishing locations of light fixtures within a facility is provided. The method comprises applying a machine-readable unique identifier to each of a plurality of light fixtures, scanning the machine-readable unique identifier to each of a plurality of light fixtures to identify each of the light fixtures, establishing the location of each of the light fixtures with regard to a site layout, and assigning the identity and location of each of the light fixtures within a facility, wherein the location and attributes of each of the light fixtures is established for the site layout within the facility. According to one embodiment, the machine-readable unique identifiers are QR codes. According to one embodiment, the machine-readable unique identifiers are bar codes. According to one embodiment, the scanning is performed with mobile app installed on a wireless device. According to one embodiment, the location of each of the light fixtures is established by user selection of a fixture location with a mobile app installed on a wireless device. According to one embodiment, the location of each of the light fixtures is established by scanning a QR code on a physically printed site layout.

According to one aspect a method for verifying locations of light fixtures within a pattern is provided. The method comprises powering on each of the light fixtures, one light fixture at a time, during the powering, verifying that the pattern of powered lights runs as expected, for any light in the pattern of light fixtures that does not power as expected, selecting the light fixture that was intended to be powered, and the light fixture that did turn on, and upon completion of the verification, updating the lighting algorithm as needed, to properly attribute the intended location of each of the light fixtures in the pattern with the actual location of the light fixtures. According to one embodiment, the method further comprises confirming the updated lighting algorithm. According to one embodiment, the confirming is performed through an AP interface on a wireless device. According to one embodiment, powering on of each of the light fixtures is performed using a carriable time interval. According to one embodiment, powering on of each of the light fixtures is performed either horizontally or vertically with respect to a grid of light fixtures. According to one embodiment, verifying is performed by a mobile application AP on a wireless device. According to one embodiment, verifying is performed by a sensor.

According to one aspect a method for establishing a lighting layout for a facility is provided. The method comprises inputting of the layout of the facility, generating photometrics for the layout, defining zones and sections for the layout of the facility, processing the layout of the facility and the defined zones and sections, and uploading the processed layout to a commissioning folder associated with a respective project for a user of the facility. According to one embodiment, the facility includes a grow room. According to one embodiment, defining is based on input received from a user. According to one embodiment, processing comprises converting light fixture locations to dots or nodes, and creating rooms, zones, and sections that correspond to the facility. According to one embodiment, processing further comprises adding lines surrounding the grid of light dots or nodes for the layout.

According to one aspect, a method for creation of a lighting schedule for a grow room is provided. The method comprises, entering desired daily light integral (DLI) parameters, creating a light schedule that matches the entered desired DLI parameters, collecting light measurements at multiple predefined locations within the grow room, and determining power levels for lights using the collected light measurement, to implement the light schedule for the grow room. According to one embodiment, entering of desired DLI parameters includes entering of one or more of number of hours in a day, length of sunrise, length of sunset, and ultraviolet (UV) percentage. According to one embodiment, entering of desired DLI parameters further includes a desired light spectrum. According to one embodiment, the light measurements are collected at different heights. According to one embodiment, the light measurement at different heights include measurements at floor level, at mid canopy level, and at top canopy level. According to one embodiment, the method further comprises calibrating the lights, and adjusting the light schedule based on the calibration. According to one embodiment, the calibration is performed with a light meter.

According to one aspect, a method for tracking plants in a growing environment that includes one or more grow rooms, during a grow process is provided. The method comprises assigning a unique machine-readable identifier for each batch of a plurality of plants, scanning the machine-readable identifier for each batch of a plurality of plants as they are placed within the grow room, and assigning a unique machine-readable identifier to the grow room, wherein the scanned plant is associated with a scanned room. According to one embodiment, the method further comprises rescanning one or more of the plurality of plants as they are moved between locations or rooms within the growing environment during the grow process. According to one embodiment, the unique machine-readable identifiers are QR codes. According to one embodiment, the unique machine-readable identifiers are bar codes. According to one embodiment, each of the plurality of plants belong to the same species or variety. According to one embodiment, rescanning occurs when the batch is subdivided into a plurality of sub-batches.

### BRIEF DESCRIPTION OF DRAWINGS

The accompanying drawings are not intended to be drawn to scale. In the drawings, each identical or nearly identical component that is illustrated in various figures may be represented by a reference numeral or character. For purposes of clarity, not every component may be labeled in every drawing. In the drawings:

FIG. 1 is a top level schematic view of an exemplary plant growing system;

FIG. 2 is a partial schematic view of an exemplary grow room and associated components, including control and IT system architecture, as described herein;

FIG. 3 is a detailed schematic view of an exemplary LED light having a DALI-2 LED driver installed in a grow room;

FIG. 4 is a schematic block diagram of an exemplary wireless sensor node;

FIG. 5 is a flowchart of an exemplary fixture commissioning method;

FIG. 6 is a flowchart of an exemplary fixture location verification process;

FIG. 7 is a flowchart of an heuristic plant growing process;

FIG. 8 is a flowchart of an exemplary wireless node procedure;

FIG. 9 is a flowchart of an exemplary creation of a lighting schedule;

FIG. 10 is a flowchart of an exemplary method for tracking plants;

FIG. 11 shows an exemplary user interface, showing details associated with an illustrative growing environment and light overview;

FIG. 12 shows an exemplary user interface, showing details associated with an illustrative growing environment and light overview, as well as specific details corresponding to one or more light fixtures;

FIG. 13 shows an exemplary system user interface associated with a wireless phone;

FIG. 14 shows an exemplary automated text-based system alarm for a wireless device;

FIG. 15 shows an exemplary system user interface associated with a wireless tablet;

FIG. 16 shows an exemplary reporting interface showing the effect of crop yields as a function of alarm reporting over a plurality of harvests;

FIG. 17 shows an exemplary reporting interface showing the relationship between energy consumption and crop yield over a set of harvests; and

FIG. 18 shows schematically, an illustrative computer on which some aspects of the technology described herein may be implemented.

### DETAILED DESCRIPTION

As described herein, embodiments of the heuristic grow data platform may automatically collect and index information available from one or more growers. In some embodiments, this information is supplemented with a wealth of other relevant information, such as specific plant information, heuristic data, lighting information, energy information, fertigation information, environmental information, alarm information, and harvest information. The system includes applications and tools by which the information is readily accessible for the user in an agricultural environment. For example, the methodology can be applied for commercial growers, with all the data available to be collected, viewed and analyzed during their existing grows.

In some embodiments, the system can control as well as monitor grow lights. For instance, some embodiments of the system can be used to schedule the length of circadian cycles and light intensities. In some embodiments, the system may modify the light spectrum profiles for stages of a circadian cycle for specific plant strains. In some embodiments, the system may provide access to real time information related to the health status of light fixtures, such as including diagnostics, temperature, and amperage.

In some embodiments, the system can monitor and control different aspects of the growing environment. For example, in some system embodiments, the user can commission, define, and update sensor locations at the facility operations scale. In some embodiments, the user can set upper and lower boundaries for alarms and notifications, and can view, manage, and filter the status of one or more aspects of the system, such as for an entire facility, for a specific grow room, or for more specific reporting, such as for a specific sensor type within one or more areas of a facility.

In some embodiments, the system enables the user to create lighting and/or environmental recipes. For instance, through a user interface, a user can set the length of any of a grow cycle, a circadian cycle, and light spectrums and intensities. In some embodiments, the user can define threshold levels for environmental inputs for the room, and can either create a new recipe from scratch, or build off a preexisting catalogue, such as from their own recipes, or from a catalog provided by or through the heuristic grow data platform.

In some embodiments, the heuristic grow data platform provides numerous insights and data analytics, such as for reports that show how the lighting and environment inputs can effect the grower's quality and yield of their plants. In some embodiments, the system can merge and analyze data captured by the heuristic grow data platform, as well as with outside sources. In some embodiments, the comprehensive data analytics, can improve or enhance previously created recipes that were based on the best prior grows.

In some embodiments, a robust user interface is provided for the grower, such as for desktop computers as well as for mobile devices, to make sure that important lighting and environmental details are captured and stored, and can be viewed and analyzed, such as a selectable time scale related to the growth of a crop; e.g., at every step in a simulated circadian cycle. While some embodiments provide such detailed information for specific crops, such as for cannabis or microgreen crops, the system and user interface may readily be customized and implemented for a wide variety of horticultural applications.

In some embodiments, through the user interface, the user can readily schedule, monitor, and modify several aspects the growing facility, equipment, and environment. For instance, some embodiments may provide a walkthrough process, where the duration of the cycle, daylight hours, and circadian steps can be set. At each interval, the user may define the desired light spectrum, with suggested spectrums or new ones. As well, through the user interface, the user may define the environmental values for the strain and the acceptable tolerance for the grow room.

As well, in some embodiments, the grower can readily access a catalogue of agricultural recipes from the system, having proven results, such as accessed through the user interface. These recipes may be applied as is, or may be modified, such as based on the grower's preferences, or based on other parameters (e.g., plants, soil, lights, HVAC limitations, and/or other environmental factors). In some embodiments, top performing recipes from historical grows can be applied as is, or edited for even better results.

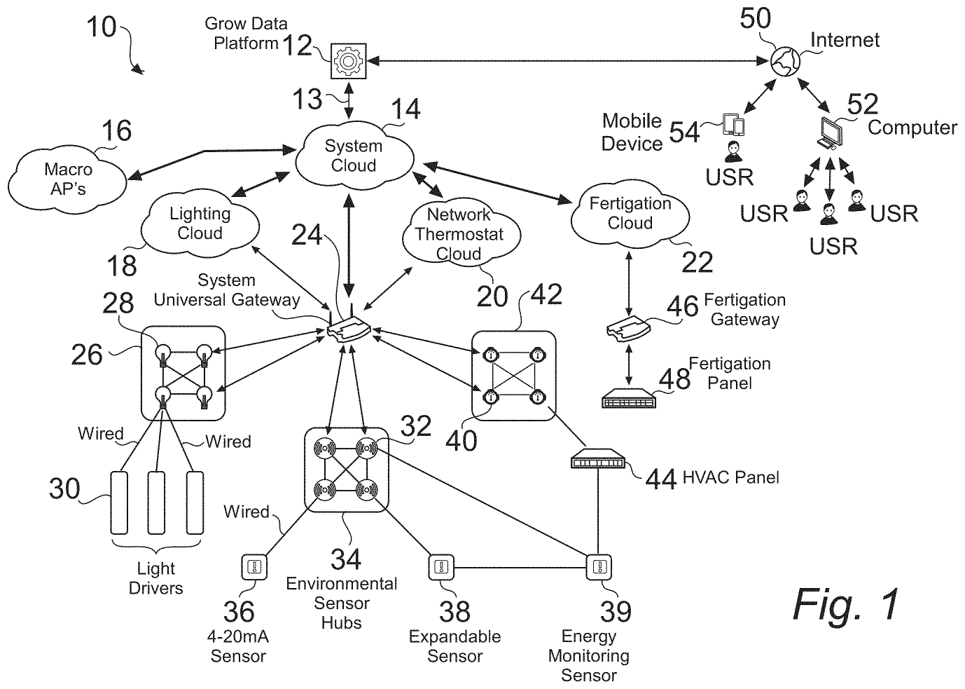

FIG. 1 is a top level schematic view of an exemplary heuristic plant production system 10. In the exemplary system seen in FIG. 1, a system gateway 24, which in some embodiments is a universal system gateway 24, can communicate with grow facility systems, such as lighting systems 26, environmental sensor systems 34, and thermostat node systems 42. In some embodiments, the system gateway or router 24 can communicate over multiple wired and/or wireless communication frequencies, such as to connect various sensors, lights, and other various facility systems in the horticulture system 10. Some embodiments of the system may include any of networked thermostats, wireless relays, and building management system (BMS) gateways, to adjust and control one or more of the systems that are implemented within the facility 102.

The exemplary lighting system 26 seen in FIG. 1 may include a wireless mesh lighting network 28 that includes a set of grow lights 28, e.g., LED grow lights 28 that include LED drivers 30. The exemplary environmental sensor system 34 seen in FIG. 1 may include a wireless mesh network of sensor hubs 32, as described herein. As also seen in FIG. 1, the exemplary environmental sensor system 34 may also be connected to one or more sensors 36, e.g., having 4-20 mA output, one or more expandable sensors 38, and/or one or more energy monitoring sensors 39.

The exemplary thermostat node system 42 seen in FIG. 1 may include a wireless mesh network 42 of thermostat sensors 40. In some embodiments, the thermostat node system 42 may also be connected to a heating, ventilation and air conditioning (HVAC) panel or local controller 44, which may also interconnect to one or more energy monitoring sensors 39.

One or more of the sensors 36, 38, and 39, and/or the sensor hubs 32 may comprise smart IoT sensors. For example, some exemplary embodiments of the system 10 may provide monitoring and automation throughout a facility 102, such as by using different types of sensors to capture environmental readings. Based on user input parameters, some embodiments of the sensors or hubs 32 may be used to trigger alarms for environmental measurements that are out of tolerance. In some embodiments, different thresholds for levels of tolerance may be defined, e.g., such as for low, medium, high, or critical thresholds. In reaction to the defined alarm states, some embodiments of the system 10 may maintain equilibrium, by automatically recognizing alarm states to trigger environment systems to auto-resolve the alarm states.

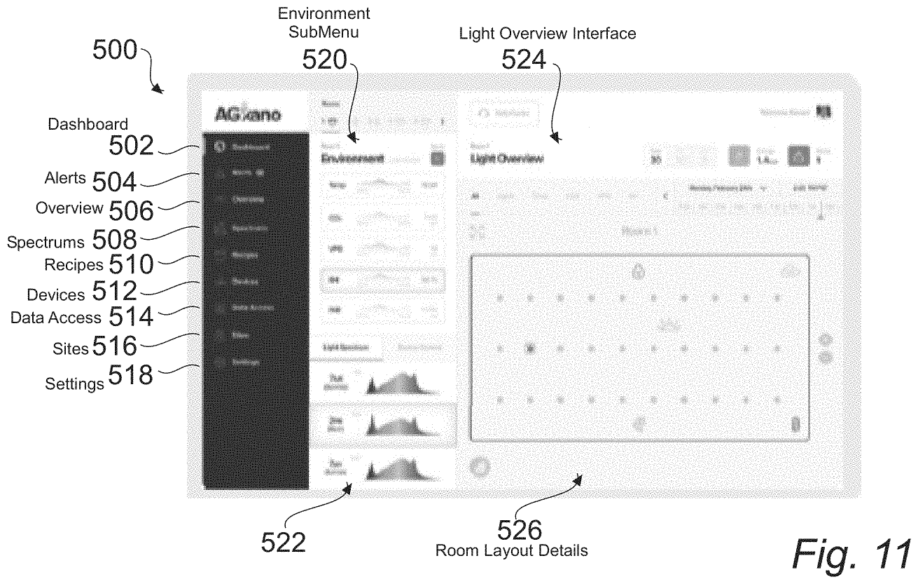

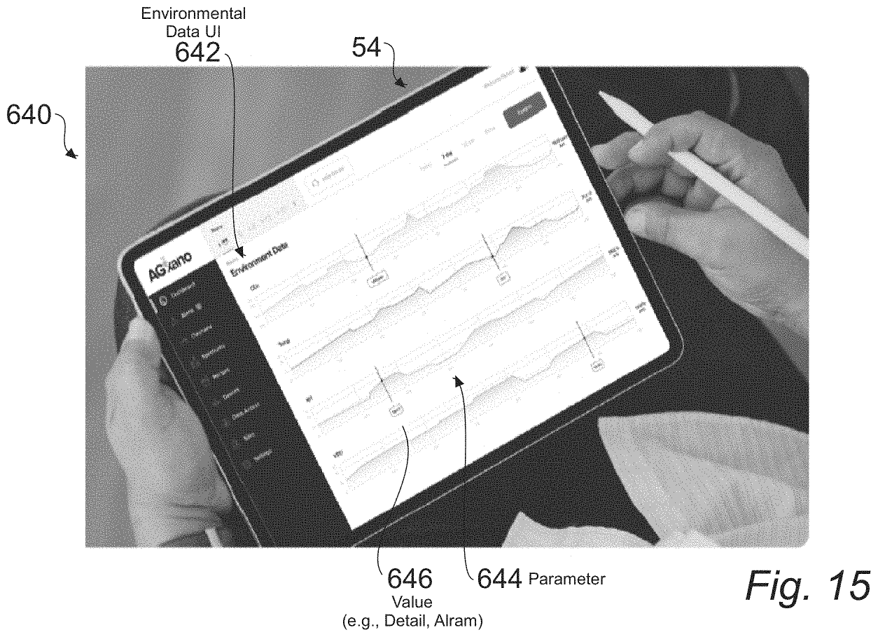

In addition to sensor operation, some embodiments of the system 10 can provide real-time visualization of one or more environmental conditions, such as through a user interface 520 (FIG. 11) and 642 (FIG. 15). In some embodiments, the user interface, e.g., 520, 642, can display a topographical (heat map) visual for a group of like-sensors within a defined space, e.g., within a grow room 104. As well, some embodiments of the user interface, e.g., 520, 642, can display historical environmental visualizations, such as by using continuous logging of data points from different sensors to generate a visualization display of a grow cycle, in which the display may also include a log of alarm states for different sensor types.

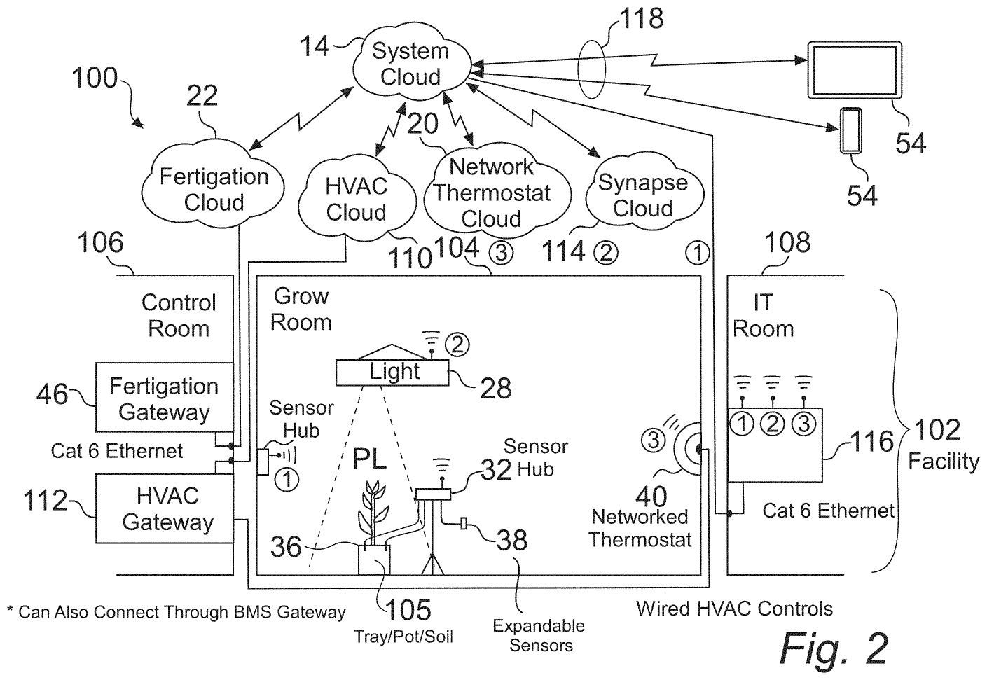

The exemplary system seen in FIG. 1 also includes a cloud network, such as comprising a system cloud 14, as well as clouds having specialized functions, e.g., such as a lighting cloud 18, a network thermostat cloud 20, a fertigation cloud 22, and one or more macro AP clouds 16. As seen in FIG. 2, some exemplary systems 10 may include an HVAC cloud 110, such as for management or tracking of HVAC hardware, e.g., HVAC panel 44 (FIG. 1), and/or a synapse cloud 114, such as for offsite storage of customer specific information, e.g., security parameters, facility information, operations parameters, alarm setpoints, customer recipes, monitoring data, and/or other legacy information.

In some embodiments, each of the clouds may be managed inhouse, such as through a single system entity, e.g., system cloud 14. In some embodiments, one or more of the clouds may be operated and/or accessed by a third party. For instance, in some embodiments, a third party may operate or manage fertigation monitoring and/or corresponding services, such as related to any of fertilizers, soil amendments, water treatment, water amendments, and/or other water-soluble products and/or services. Such responsibilities may be integrated with other system operations, such as to confirm or change placement of environmental sensors 36, 38, 39. In some embodiments, a third party may be used to operate or manage the lighting system and/or the HVAC system, and may be responsible to related hardware and/or communication networks or cloud services. In such embodiments, the system 10, such as through the system cloud 14, may interface with third party hardware and networks, such as to pull or otherwise receive data from the other subsystems, which can then be processed by the system 10.

As well, some embodiments of the grow data platform 12 can leverage information from one or more external sources, and can integrate such external information with internal system information, such as including information provided by the grow data platform 12, and information provided by one or more users USR.

Some embodiments of the system 10 may be configured to aggregate environmental data from third party systems, such as through API, data export, and/or data scraping. As well, some embodiments of the system 10 may be configured to bring in data from previously installed systems, such as including any of fertigation systems, facility systems, compliance systems, enterprise resource planning (ERP) systems, and/or other systems. Furthermore, some embodiments of the system 10 may be configured to select data to acquire, query, or otherwise receive data that is collected by sensors and/or outside sources, such as to leverage to determine key inputs that the grow data platform 12 can use to improve plant yield and/or plant health.

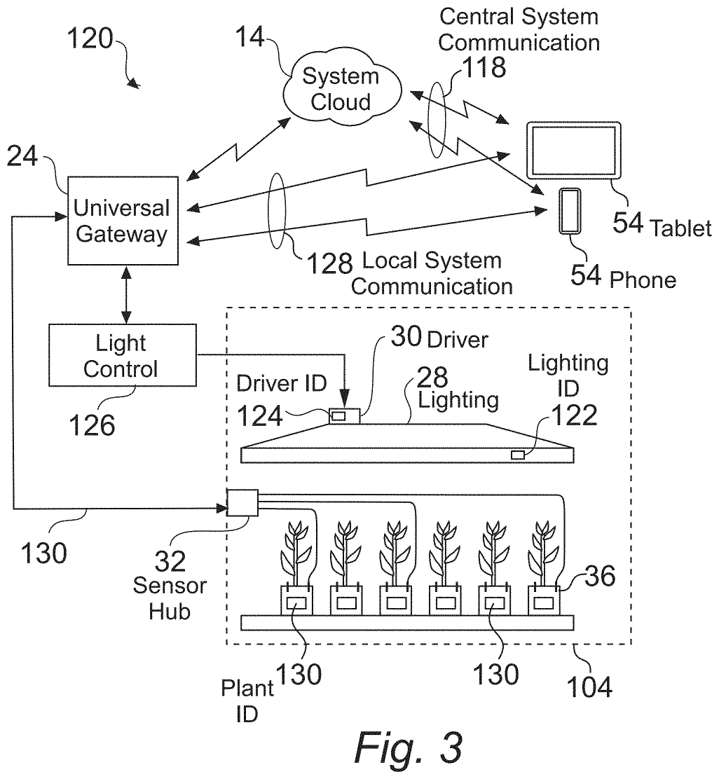

In some embodiments, the system gateway 24, e.g., a system universal gateway 24, aggregates different systems to monitor, control, and record data. In some embodiments, the system gateway 24 is connected via ethernet for internet access 50, and is connected, e.g., 128 (FIG. 3), either directly or through one or more clouds, to provide remote access. In some embodiments, the system gateway broadcasts over a Wi-Fi for local connections 128, and can communicate via SNAP Mesh radio, e.g., a 2.4 GHz 802.15.4 system.

In some embodiments, the system gateway 24 can provide data storage, such as to retain local data. In some embodiments, a user USR can access the system gateway 24, such as through a computer 52 or wireless device 54, e.g., a tablet or mobile phone, to create and manage multiple zones, events, and schedules.

In some embodiments, the exemplary lighting system 28 seen in FIG. 1 comprises a mesh network of lighting nodes 26, that includes lighting fixtures 28 having associated LED drivers 39, e.g., DALI-2 compliant drivers 30. The exemplary environmental sensor system 34 seen in FIG. 1 comprises a mesh network of wireless environmental sensor hubs 32, in which the sensor hubs 32 may include one or more integrated environmental sensors, and may receive environmental data from one or more external and/or expandable sensors, such as having a 4-20 mA output signal. In some instances, one or more of the environmental sensor hubs 32 can be used to track input from an energy monitoring sensor 39. In some embodiments, the sensor hubs 32 may include internal circuitry to capture and process raw sensor signals (e.g., type “K” Nickel-Chromel/Nickel-Alumel, or type “T” Copper/Constantan thermocouples), such as to include temperature compensation for twisted wire pairs.

The exemplary thermostat system seen in FIG. 1 comprises a mesh network 42 of thermostat nodes 40, which may also be connected to an HVAC panel 44, which, in turn, may also be connected to one or more energy monitoring sensors 39.

Some embodiments of the heuristic grow data platform 12 can provide multiple levels of energy monitoring and energy reduction. For instance, some embodiments of the heuristic grow data platform 12 can monitor and analyze the energy used for lighting systems 26 throughout the facility 102. In some embodiments, the smart light drivers 30, e.g., DALI-2 compliant drivers 30, may be used to measure and display energy readings for fixtures at the light level, room level, facility level, and portfolio level in the grow data platform 12. Some embodiments of the grow data platform 12 can be used for any of graphing, manipulating, and analyzing the acquired energy data. As well, some embodiments of the grow data platform 12 may process this data to identify any anomalies in data set that may adversely affect any of energy use, lighting performance, and/or grow conditions. In some embodiments, this information can be used for predicative analytics and maintenance on the assets and components of the system 10.

In some embodiments, the system 10 may monitor and analyze energy use for the facility 102, such as by using energy monitoring sensors 39 to measure and display energy readings for various facility systems (A/C, fans, humidifiers, etc.) at the machine level, room level, facility level, and portfolio level in the grow data platform 12. In some embodiments, the monitored data may be processed to identify anomalies in a data set that could be raising energy use throughout the facility 102, such as for predicative analytics and maintenance on the assets and components. In some embodiments, the data can be processed to identify optimum (in terms of energy use, affects to plant health and yield) ways and times to use facility systems to adjust environmental conditions. For example, if CO₂ needs to be raised, the system 10 may be used to determine if the temperature of the grow room 104 should be raised, and/or if CO₂ should be added to the grow room 104.

In some exemplary embodiments, the system 10 may provide suggestions by which the use of energy can be reduced. For instance, some embodiments of the system 10 may automate and optimize energy use of lights 28 and/or facility systems, by reducing the cost of energy, such as by taking into account energy rates, peak energy rates, reducing energy loads of using facility systems at varying times, worker scheduling, and/or harvest objectives. In some embodiments, the system 10 may provide recommendations to the user USR, such as based on any of how to reduce energy use, how to reduce an energy bill, how to improve plant health, how to improve plant yield, and how to increase asset and component life.

In some embodiments, the system 10 may perform predictive analytics on the light drivers 30, by using historical average temperatures, energy spikes, usage, and other factors to anticipate the probability of failure. In some embodiments, the system 10 may estimate the chance of failure within a facility, and may suggest batched repair schedules to minimize downtime.

The exemplary system seen in FIG. 1 also comprises a communication link 13 between the system cloud 14 and the main system platform 12, such as referred to herein as the system grow data platform 12, which can also be accessed, such as over the Internet 50, from user terminals, such as including computers 52 and/or wireless devices 54, e.g., wireless tablets and/or mobile phones. As described herein, the system 10 can be used to provide a feature-rich user interface for user terminals, such as to allow any of grow room setup and calibration, recipe search and selection, light spectrum review and control, reporting of alarm conditions, as well as data monitoring and analysis, and detailed reporting of harvest results.

In some embodiments, the system grow data platform 12 may provide users USR with tailored suggestions on how to harvest better throughout a grow, such as including what to look for in the crops, e.g., coloring, mold, and/or wind burn. In some embodiments, the suggestions provided by the grow data platform 12 may be specific to any of growth stage, plant type, grow room type, nutrients, and/or other environmental factors.

In some embodiments, the grow data platform 12 may provide automated plant tracking, such as through the use of plant identifiers, e.g., QR codes or bar codes, to follow plants PL which are transported to multiple rooms through the grow process. In some such embodiments, each plant PL is labeled with a barcode, and scanned when moved to a room 102. Each room 102 can also be labeled, such as identified with a QR code, and when scanned, automatically associates the plant QR code to a batch, even when batches of plants PL are subdivided. In some embodiments, the grow data platform 12 can automatically handle the merging of plants and the environmental inputs, such that the entire history of a plant PL can be tracked throughout the plant production system and process.

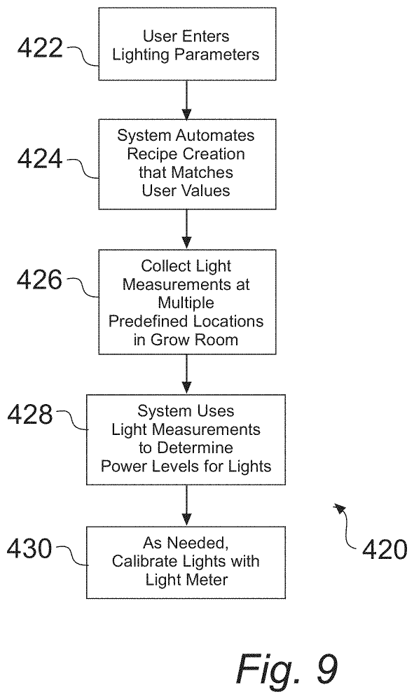

Some embodiments of the grow data platform 12 provide a user interface through which a user USR may be guided through the automated creation of a lighting schedule for a grow room 104. For instance, FIG. 9 is a flowchart of an exemplary creation 420 of a lighting schedule, by which the grow data platform 12 can automatically create a lighting schedule using daily light integral (DLI) information, such as based on the number of photons that hit the ground at a given point in time, at different points throughout a growing area, e.g., a grow room 104. In some embodiments, the user USR can start by entering the desired DLI information. In some embodiments, the user USR may also enter one or more of number of hours in a day, length of sunrise and sunset, ultraviolet (UV) percentage, and where applicable, a desired light spectrum, such as described herein. The grow data platform 12 may then create 424 a lighting schedule or recipe that matches the user entered values. In some embodiments of the process 420, light measurements are collected 424 at multiple predefined locations throughout the grow room 104. For example, in some embodiments, a light meter may be used to determine number of photons in grow room 104, by collecting 426 multiple light measurements at strategically defined points in the room, e.g., at different heights of the floor, at mid canopy, and at canopy height. In the exemplary process seen in FIG. 9, the grow data platform 12 can use the collected 426 light measurements to determine what percentage to set one or more lights 28 at, such as when a user USR inputs a DLI measurement. In some embodiments, when the available light percentages for one or more lights are measured or otherwise determined for be less than 100%, the grow data platform 12 and/or local controllers can adjust light levels to compensate, such as to increase the light level for areas in a grow room 104 where a lower number of photons are present.

In some embodiments, the process 422 may also automate calibration 430 of the lights 28, such as with a connected light meter that is operated by a person, by a machine, or by one or more stationary light meters. As well, in some embodiments, the process can be implemented, reviewed, and/or modified through user computers 52 and/or mobile devices 54, which may provide a simplified user interface (UI) and user experience (UX), wherein the complicated process of setting advanced lighting and environmental conditions may readily be implemented by the user USR, such as on a periodic basis, as the performance of more or more lights 28 change, or as one or more lights are changed out.

Some embodiments of the grow data platform 12 may identify and automate the application of stressors at different points in a growing process. For example, during the cultivation of cannabis, the “flush” or last week of a plant's growth is marked by stress of environmental conditions. At this time, a grower USR may seek to come close to killing the plant PL, without actually doing so. For such conditions, some embodiments of the grow data platform 12 may identify anomalies during this period, and throughout the grow, such as to interpret conditions which are most effective to produce desired quality traits in crops.

FIG. 2 is a partial schematic view 100 of an exemplary grow facility 102, such as comprising a grow room 104 and associated components, control and IT system architecture, as described herein. The exemplary grow facility 102 seen in FIG. 2 includes one or more adjoining areas for housing system hardware, such as a control room 106 and an information technology (IT) room 108. The exemplary control room 106 seen in FIG. 2 may be used to house hardware such as gateways (e.g., a fertigation gateway 46 and/or an HVAC gateway 112), panels, and/or other localized components or hardwired communication channels, e.g., ethernet cables and modems.

FIG. 3 is a detailed schematic view 120 of an exemplary LED light 28 having a DALI-2 LED driver 30 installed in a grow room 104. The exemplary light fixture 28 shown in FIG. 3 may include a unique light identifier 122. As well, the exemplary LED driver 30 seen in FIG. 3 may include a unique driver identifier 124. In some embodiments, the light identifier 122 and/or the driver identifier 124 may be machine readable, such as including a bar code or QR code, by which a respective light 28 and/or driver 30 may readily be identified, such as during or after installation. In some embodiments, the system interface for mobile devices 54 can include an application for scanning the light identifier 122 and/or the driver identifier 124. Similarly, the system 10 may be used to determine the locations for the identified light 28 and/or driver 30.

In some embodiments, the system 10 may use the light identifier 122 and/or the driver identifier 124 to predict the remaining life of the corresponding light fixture 28 and/or the LED driver 30. For example, one of the functions of a light driver 30 is to convert external AC power to DC power that is compatible with a connected light fixture 28. A key influence on the active life of a light driver 30 is the temperature at which the driver 30 operates, which can be influenced on the heat produced by the power conversion, which creates localized heat.

To estimate the remaining life of the corresponding light fixture 28 and/or the LED driver 30, some embodiments of the system 10 may monitor and record one or more operating parameters, such as including any of run time, ambient temperature, temperature spikes, and/or energy surges. In some embodiments, the tracked data can be compared to a stored schedule of estimated life, such as determined by the grow data protocol system 12, and/or as provided by the manufacturer of the light driver 30, which may typically be specified for operation at a certain temperature. The level of confidence in the predicted life of a light driver 30 and/or corresponding light fixture 28 by the system 10 may be improved over time, such as through the integration of heuristic data gathered by the system 10.

As described herein, through the use of fixture IDs 122, e.g., QR codes, and the knowledge of where a light fixtures 28 are located within a grid, some embodiments of the system 10 may keep an active inventory as to what light fixtures 28 are currently used within a grid or matrix of lights 28. As well, the system 10 may track specific light fixtures 28 that are available as spares for the grid or matrix of lights 28, such as to avoid or minimize downtime. Such information can be integrated into a schedule for repairs. While such repairs may be done at night, the grow lights 28 are not typically run at night, because it may cause certain types of plants PL to hermaphrodite. To minimize such effects, such repairs can be batched and performed quickly, as some embodiments of the system 10 can provide a specific map for the fixtures 28 and work to be done, and also may indicate what other lighting can remain on during the service process.

As also seen in FIG. 3, some embodiments of the system may include a local light control module 126, such as responsive from the system cloud 14 through the system gateway 24, to control a network 26 of one or more lights 28, through respective drivers 30. In some embodiments, operations parameters may be communicated to wireless user devices 54, such as over a local network 128. As well, set up and control of system hardware, such as the lights 28 and drivers 30, may be implemented through user devices 54.

The exemplary system 10 seen in FIG. 3 also shows a communication link 130 between the universal system gateway 24 and one or more sensor hubs 32, which can be used to monitor different environmental parameters. For instance, as seen in FIG. 3, moisture sensors 36 may be placed at one or more depths in one or more plant pots or trays, by which the system 10 can determine representative measurements of soil moisture across a grow room 102. In some system embodiments, multiple soil moisture sensors 36 may be deployed along the same irrigation line, and in multiple locations of within specific pots, to measure where liquid starts diffusing differently. Some embodiments of the system 10 may include a step-by-step process, such as accessed through the user interface of one or more devices 52, 54, which can instruct growers USR which plants PL to place one or more soil moisture sensors 36 in. In some embodiments, the process may provide specific details regarding the 3-dimensional location for the user USR to install a moisture sensor 36, and may also provide specific details regarding the installation of multiple moisture sensors 36 within a pot. In some embodiments, the process can take into account specific details regarding a specific grow, and in some embodiments, the process can be improved as it is implemented, such as through machine-learning and/or through heuristic feedback.

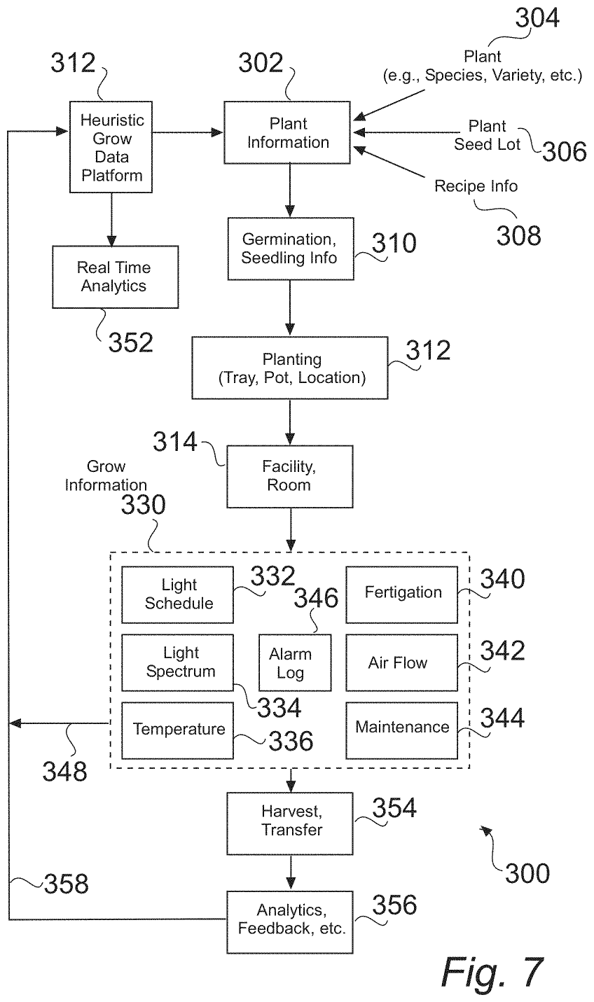

In some embodiments, the system 10 can control the lights 28, such as with the drivers 30, to mimic the circadian rhythm of the Sun in horticulture applications. In some embodiments, the system 10 may incorporate heuristic information, e.g., 358 (FIG. 7) from prior harvest results to optimize the circadian rhythm for a particular type of plant PL. In some embodiments, the wireless lighting 28 can be controlled to tune the spectrum with white light in horticulture applications. Such control may integrate heuristic information 358 from prior harvest results to optimize light spectrum for a particular type of plant PL.

In some embodiments, the system 10 can include automated supplemental lighting control 126, optionally through the use of wireless lighting controls, and smart drivers 30, to raise and lower the intensity of a light 28 in a horticulture application multiple times throughout a day, and throughout the harvest. Such embodiments may also heuristically apply information 358 from past harvest results to optimize when, how often, and what spectrum and intensity to use for a particular type of plant PL. In some embodiments, light sensors, e.g., 36, can be used to measure the amount of light emitted from a fixture 28, wherein the system 10 can automatically adjust the brightness of a light 28 to meet the desired intensity. As well, in some embodiments, light sensors 36 can be used to physically verify that lights 28 have been powered on at times that have been predefined by the grow data platform 12.

In some system embodiments that are established in a greenhouse environment (e.g., such as for a glass roofed indoor grow room, natural light from the Sun can be supplemented with a lighting system 26. In some such embodiments, light sensors 36, e.g., a photosynthetically active radiation (PAR) meters 36, can be used within the greenhouse, to measure the amount of light the cultivated plants are receiving from the Sun, i.e., to count the number of photons that are hitting the ground. In combination with the measured sunlight, some embodiments of the drivers 30 may controllably adjust the intensity of the lights 28 to meet the desired amount of supplemental light. In some such embodiments, as described herein, the system 10 can also modify the intensity and spectrum of the supplemental light throughout the day, such as to provide a specific spectrum around dawn and dusk. In some embodiments that measure the ambient sunlight throughout the day, the supplemental light can be adjusted, such as based on ambient conditions, e.g., cloud cover, fog, rain, haze, smog, or shade. Under such conditions, when the ambient light falls below a pre-determined threshold, the system 10 can raise the light intensity. Similarly, when the measured natural light is above an upper pre-determined threshold, the system 10 can lower the intensity.

In some embodiments, the intensity of the lighting system 26 can be automatically adjusted based on the height of the cultivated plants PL, with respect to the lights 28. For instance, in some embodiments, wireless lighting control drivers 30 can be used to adjust the intensity of the lights 26, as the crops grow taller, to keep the amount of light at the canopy constant.

In contrast to some indoor growing systems that require workers to frequently raise lights as the plants grow, to maintain a fixed canopy height above the plants, some embodiments of the system 10 described herein can delay adjusting the height for the lights 28 while, based on a calculated or stored algorithm that determines how quickly the plants grow, such as based on the crop, species and variety, the light drivers 30 may controllably decrease in the intensity of the lights 28. In this manner, rather than having to physically adjust the light level often, e.g., every 2 days, the system 10 can compensate for at least some of the plant growth, such that the interval between light height adjustment can be extended, e.g., every 4-5 days.

As described herein, in some embodiments, the intensity and spectrum of the lighting system 26 can be controlled based on one or more factors. For instance, the spectrum of the lights 28 can be tuned, such as based on a long-term schedule, and/or as adjusted at different times within the growing season. For example, the system 10 may controllably modify the reds and blues in the light, to mimic the sunrise and/or sunset.

In some environments, the lighting system 26 is controlled to mimic or imitate the Sun, in different ways, such as by mimicking the sunrise and sunset, within the environment of the grow room 104 or greenhouse. In some embodiments, the lighting system 26 may be controlled further, such as related to ramp up and ramp down procedures at the start and end of the day, e.g., in terms of setting the duration and the convexity of the sunrise and sunset. In some embodiments, the light drivers 30 may modify the spectrum of the light 28, such as by adding more reds to the light in the morning time, and/or by adding blues to the light in the evening time. While some embodiments are configured to control and/or modify the intensity and/or spectrum of colored LED lights 28, in some embodiments, the system 10 can control and/or modify the intensity and/or spectrum of white LED lights 28.

While multicolored LED lights 28 can be used for horticultural applications, recent studies, such as reported in Theraspecs and the National Headache Institute, have shown that exposure to colored LED lights can lead to higher rates of headaches and migraine symptoms. As such, some embodiments of the light system 26 as described herein use white LED lights 28, which may be controlled to produce a desired spectrum and/or intensity. The use of white LED lights 28 can allow horticultural personnel USRs to work within the grow rooms 104 for extended periods of time.

In some embodiments, the light intensity and spectrum are automatically controlled by the lighting system 26, such as managed by the drivers 30, through the system controller 126 (FIG. 3). In some embodiments, the lighting parameters can be controlled to match a specific recipe, which may be integrated with other environmental factors, such as including any of ambient temperature, relative humidity, soil temperature, soil moisture, soil pH, pressure, and carbon dioxide (CO₂) level.

In some embodiments, an indoor grow may typically include a single type of crop strain, in which the plants PL generally grow at the same rate. Under such conditions, the system 10 may typically control all of the lights 28 similarly with regard to intensity, spectrum and time of day. In some growing environments, such as for greenhouses and/or large facilities, some embodiments of the system 10 may compensate for changing environmental conditions and/or different plant growth rates. For instance, with the use of one or more light sensors 36, the system 10 may determine and compensate for different boundary conditions, e.g., to decrease supplemental light in regions of the crop that experience higher levels of ambient light, and/or to increase supplemental light in regions of the crop that experience lower levels of ambient light.

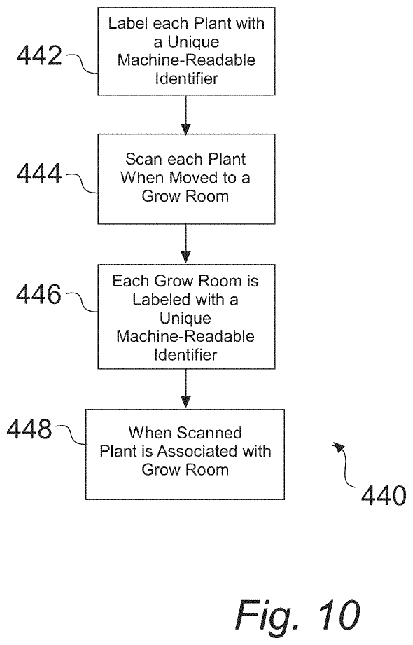

In some embodiments, the software and lighting controls 126, 30 can offset different lights to different lighting intensities, such as within a large grid 526 (FIG. 10), to create a more uniform pattern.

In some embodiments, the software and lighting controls 126, 30 can be configured to automatically acclimate plants as they are introduced to a new grow room 104, such as for an indoor grow or a vertical grow, from a different environment. For instance, some embodiments of the grow data platform 12 can take into consideration the initial condition of the plants PL, such as with respect to their current age, stage, and/or size, along with their current circadian cycle and other environmental factors from their past growing environment, and can adjust any of the light schedule, intensity and/or spectrum of the lights 28. As well, other environmental factors may be controlled by the grow data platform 12 as part of the acclimation process (e.g., temperatures, plant orientation, moisture, fertigation, etc.).

As the plants are acclimated, any of the light schedule, intensity and/or spectrum of the lights 28 may be controllably stepped to meet the needs of the grow. For instance, during a latter maturity of some plants PL, the light schedule, intensity and/or spectrum of the lights 28 may be controlled to accentuate one or more aspects of the plants PL. In some embodiments one or more environmental factors may also be controlled by the grow data platform 12 to improve the yield and/or quality of one or more portions of the plants PL. As well, the light schedule, intensity and/or spectrum of the lights 28 may be controlled to account for tracked environmental factors, such as to increase the light intensity under conditions in which the delivered light may be decreased by relative humidity, haze, or other air conditions, e.g., elevated CO₂ levels.

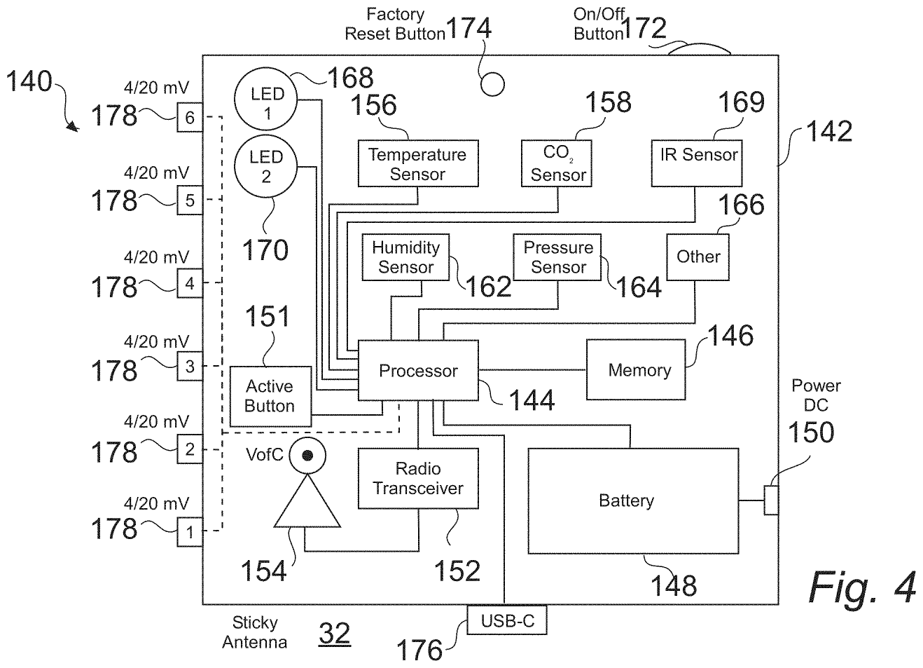

FIG. 4 is a schematic block diagram 140 of an exemplary wireless environmental sensor hub 32, which may be installed and operated within a grow room 104. In some embodiments, the sensor hub 32 can be implemented to gather multiple types of data within a growing environment, such as through onboard sensors, and/or through connected external sensors, e.g., 36, 38, and/or 39.

For example, the exemplary sensor hub 32 seen in FIG. 4 may include one or more of a temperature sensor 156, a pressure sensor 164, a relative humidity sensor 162, a CO₂ sensor 158 (e.g., single or dual channel), an infrared (IR) sensor 169 (e.g., for measuring canopy temperature), and/or other sensors 166, e.g., an accelerometer, such as to detect high vibrations that may affect sensor accuracy. In some embodiments, the sensor hub 32 may include one or more of an atmospheric pressure sensor, a window/door open/close sensor, and an occupancy/motion sensor. In some embodiments, the coverage area for a sensor hub 32 may be determined for a grow room 104, such as to finalize the number of I/O channels that are needed to adequately monitor the grow room 104. As well, in some system embodiments, the maximum cable length may be determined before signal degradation occurs from connected sensors, e.g., 36, 38, or 39, to confirm the number of sensor hubs 32 needed for a specific grow room 104.

In some embodiments, the sensor hub 32 may be adapted to receive and process signals 178 (e.g., 4-20 mV) from external sensors or transducers 36, 38, and or 39, such as from one or more of a photosynthetically active radiation (PAR) sensor, a soil moisture sensor, a pH sensor, an EC sensor, and a root temperature sensor.

The exemplary sensor hub 32 seen in FIG. 4 includes a processor 144 and an associated memory 146 (e.g., such as RAM and storage), as well as onboard power 148, such as a battery or as provided by a constant power source 150. In some embodiments, the sensor hub 32 may include a USB port 176 (e.g., USB-C) as shown, which may be used by a technician for troubleshooting and/or for downloading data. In some embodiments, the USB port 176 may be used for feature expansion and/or peripheral attachments, such as for a camera or memory. If a USB port 176 is not currently used, the sensor hub 32 may include an attached rubber grommet to seal the port 176 when not in use.

The exemplary sensor hub 32 seen in FIG. 4 may also include radio circuitry 152, such as a transceiver 152, as well as an antenna 154, such as a stick or adhesive antenna 154.

The exemplary sensor hub 32 seen in FIG. 4 includes a user interface UI that may include LED1 168, LED2 170, a factory reset button 174, and an On/Off power button or switch 172. In embodiments of the sensor hub 32 that include a CO₂ sensor 158, the user interface may include a CO₂ calibration button.

In some embodiments, LED1 168 may be used to indicate the status of the battery 148. For instance, in some embodiments, when the user presses the active button 151, LED1 may display 1 of 4 colors, to indicate remaining battery life. In some embodiments, LED2 170 may be used to indicate connection status and/or strength. For instance, in some embodiments, when the user presses the active button, LED2 may display 1 of 4 colors to indicate a connection strength.

In some embodiments of the sensor hub 32, the factory reset button 174 may be a recessed button 174, and may require a pin-like device to activate. In some embodiments, setting the sensor hub 32 to factory settings may be initiated by a user, such as by depressing the factory reset button 174 for a predetermined time (e.g., 5 seconds). Responsive to initiating the reset procedure, LED1 168 and/or LED2 170 may be used to display the status of the reset operation, such as to display any of “in progress”, success”, or “failure”.

The exemplary sensor hub 32 seen in FIG. 4 also includes an active button 151, such as to provide one or more local functions. For instance, in some embodiments, clicking on the active button 151 once may initiate a status procedure, whereby LED1 168 and/or LED2 170 may be illuminated to display one or more status conditions. In some embodiments, holding the active button 151 for a pre-determined time (e.g., 10 seconds) may be used to initiate a calibration process, wherein LED1 168 and/or LED2 170 may be used to display calibration modes, e.g., “in progress”, “success”, or “failure”.

As noted above, the exemplary sensor hub 32 seen in FIG. 4 may include one or more ports 178, such as universal ports, for connecting sensors. In some embodiments, the ports 178 may include a clip or latching mechanism for secure connections. In some embodiments that are connected to system-specific sensors, the ports 178 may be configured as female ports, to match to system-specific sensors having male terminal plugs for connection to the ports 178.

Some embodiments of the sensor hub 32 may have an ingress protection rating, e.g., IP67, to provide enhanced environmental protection, such as from any of dust, dirt, sand and water. As well, some embodiments of the sensor hub 32 may be resistant to sunlight. In some embodiments, the sensor hub may be battery powered 148, and may be rechargeable. In some such embodiments, a solar cell may be used to passively charge one or more batteries 148, such as through DC port 150.

Some embodiments of the sensor hub 32 may include a unique ID, e.g., a barcode or a QR code, such as for quick identification of the hub 32 as well as for other connected sensors (e.g., 36, 38, and 39). In some embodiments, the sensor hub 32 may be mounted by one or more methods, such as with a base plate, or with a tripod canopy mount. Some embodiments of the sensor hub 32 may include an IP rating, such as to provide enhanced resistance to one or more environmental hazards. In some embodiments, the sensor hub 32 may be embodied with a sleek industrial design, such as to accentuate the quality of the sensor 32, and to be easily cleaned.

Some embodiments of the sensor hub 32 may include one or more wireless connections and options. For instance, as described above, some embodiments of the sensor hub 32 can be integrated within a mesh network 34. As well, some embodiments of the sensor hub 32 may be rated for different ranges, or provide a solid range. Furthermore, some embodiments of the sensor hub 32 may include one or more levels of encryption and/or other security. Some embodiments of sensor hubs 32 may provide circuitry and/or connections with which to perform periodic network connections. Some embodiments of networked sensor hubs 32 may offer compatibility with current as well as future lighting controls.

Some embodiments of the sensor hub 32 may include or be supplied with one or more commissioning features, such as hardware for easy installation (e.g., wall, canopy, plant, hang), a tool to measure signal strength of an installation point, circuitry that automatically searches for a gateway when connected to power, and compatibility with barcoding commissioning processes for lights, such as within one or more zones within a grow room 104, as described herein.

Some embodiments of the sensor hub 32 may include one or more other software features. For instance, some embodiments of the sensor hub 32 may be assignable to multiple zones within a grow room 104. In some embodiments, the polling period may be adjusted or modified, such as based on based upon a variety of factors, e.g., to maximize battery life without affecting data integrity. Some embodiments of the sensor hub 32 may be individually addressed from the grow data platform 12, and in some embodiments, the sensor hub 32 may be reassigned, such as based on the location of a zone or grow room 104. While some embodiments of the sensor hub 32 may require wired updates, some embodiments of the sensor hub 32 may be updated over the air (OTA).

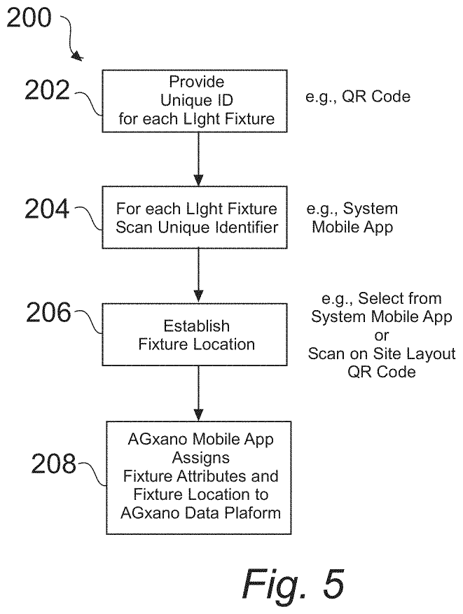

FIG. 5 is a flowchart of an exemplary fixture commissioning method 200. As described herein, each of the light fixtures 28 and/or corresponding light drivers 30 may include a unique ID, such as a QR code sticker 122 or 124, that is applied 202 to a visible location, which may remain visible even after installation. For each of the light fixtures 28, a user USR can scan the QR code 122,124, such as by using an associated mobile app on a wireless device 54, and then establish 206 the fixture location, such as by selecting the fixture location on the associated mobile app, or by scanning a QR code on a physically printed site layout. Once the light fixture 28 is identified 204 and located 206, the associated mobile app or the grow data platform can assign 208 the fixture attributes and its location within the grow data platform 12.

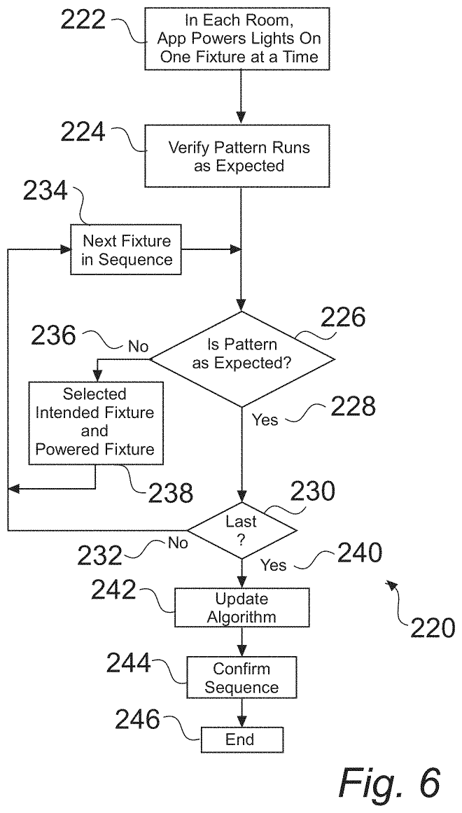

FIG. 6 is a flowchart of an exemplary fixture location verification process 220. In some embodiments, the process 220 may start a light cycle, by powering 222 the lights 28 on, e.g., one fixture at a time, in a grow room 104, such as at a variable time interval. In some embodiments, the powering 222 may progress either horizontally or vertically with respect to a grid 526 (FIG. 10) of lights 28. During the powering 222, a worker, such as with a mobile application AP on a wireless device 54 or with a sensor, can verify 224 that the power pattern 222 runs as expected. If a light 28 the pattern 222 is determined 228 to run as expected, unless the last light has been verified 240, the process returns 232, to verify the next fixture 28 in the sequence. If the pattern is not as expected 236, the worker may select 238 the fixture 28 in the AP which was intended to turn on, and the fixture 28 which did turn on. After this verification process is determined 230 to be complete 240, the grow data platform 12 can update the lighting algorithm, if necessary, to determine which lights 28 need to be switched. In some embodiments, the AP can be used to turn on the lights 28, one-by-one, which were switched, to show the worker, through the AP, which lights 28 are expected to be turned on. After the entire sequence is confirmed 244 by the worker, such as through the AP interface, the verification process 246 may be marked as completed 246.

FIG. 7 is a flowchart of an exemplary heuristic plant growing process 300. For instance, a user USR may enter 302 information regarding a specific crop of plants PL to be grown, wherein the information may include any of plant species, plant variety, and plant seed lot. The entered information may also include recipe information for the intended crop. The user may also enter other information 310 regarding the plants, such as germination or seedling information, and planting information 312, such as associated with a tray, pot, soil, or location. Information 314 regarding the facility and/or grow room 104 may also be entered, such as including light hardware and history, sensor information, and environmental information. During the grow, grow information 330 is collected, such as including data associated with light schedule 332, light spectrum 334, temperature 336, fertigation 340, air flow 342, maintenance 344, and alarm log data 346. As the grow proceeds, the gathered data 330 may be stored at the synapse cloud 114, and may also be communicated 348 back to the grow data platform 12, such as to provide real time analytics 352. At the end of a grow, such as when crop of plants PL is harvested or transferred 354, information regarding the harvest may be entered 354, and specific analytics, such as yield, dry weight, trim weight, and other analytic values may be entered 356, wherein such information may be stored at the synapse cloud 114, and may also be communicated 358 back to the grow data platform 12, such as to provide heuristically information that may be applied to future crops to the same or for other users USR. For instance, some embodiments of the grow data platform 10 are configured to look at a grower's past grows, and aggregate the user's data, such as to create or add to a catalog of heuristically optimized recipes, which may be provided back to the grower USR, such as a software service. As described above, such information may include specific details about the species and variety of a plant, that can be combined with other grow details, such as to be used to highlight details for any of light schedule, light spectrum, temperature, humidity, fertigation, or other environmental data, to determine how the user or other users USR may improve future grows, and provide recommendations or “recipes” by which future crops can be managed.

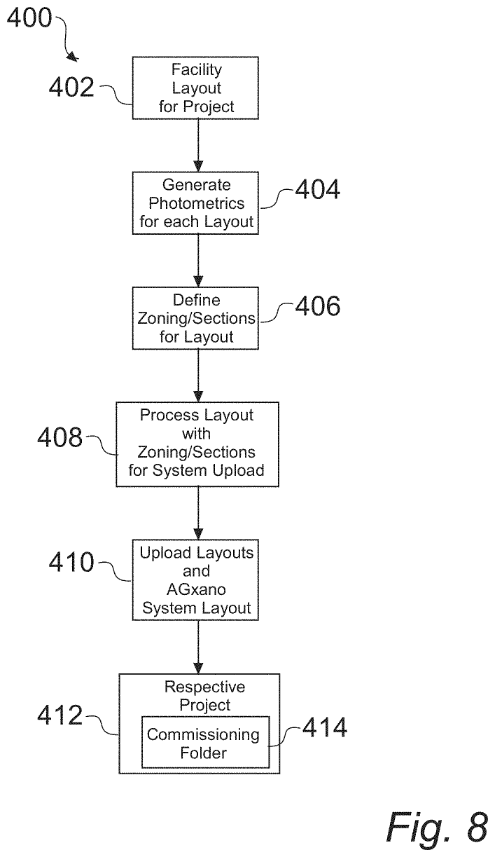

FIG. 8 is a flowchart of an exemplary wireless node procedure 400, by which a lighting layout may be established for a grow room 104, to be stored and used within the grow data platform 12, such as accessed through the synapse cloud 114, for subsequent plant production operations. The exemplary wireless node procedure 400 seen in FIG. 8 includes the input 402 of the layout for the facility 102 or grow room 104. The photometrics are then generated 404 for the layout, such as using input from an applications engineer. As well, the zones and sections of the layout are defined 406, such as based on user or grower input. The established layout, including the defined zones and/or sections, are then processed 408, such as to convert fixture locations to dots or nodes, and to create rooms, zones, and sections that correspond to the facility 102 or grow room 104, such as by adding lines surrounding the grid of light dots or nodes. The defined layout, as well as the grow data platform layout, are then uploaded 410 to the grow data platform 12, such as to a commissioning folder 414 associated with a respective project 412 for the user or grower USR.

FIG. 10 is a flowchart of an exemplary method 440 for tracking plants PL, such as in an indoor growing environment. As seen in FIG. 10, each plant PL of a batch of plants PL is labeled 442 with a unique machine-readable identifier 130 (FIG. 3), such as a QR code or a bar code. Each plant PL us then scanned 444 when it is moved to a grow room 104. As well, the grow room 104 may also be labeled 446 with a unique machine-readable identifier, which, when scanned, such as before or after the plant PL is moved into the grow room 104, the plant PL can be associated 448 with the grow room 104. This scanning procedure may be repeated, such as each time a batch of plants PL is subdivided, or when the pants are moved. In this manner, identified plants PL can be tracked and followed as they are transported to one or more grow rooms 104 throughout a grow process.

FIG. 11 shows an exemplary user interface 500, showing details associated with an illustrative growing environment and light overview 524. For instance, the exemplary user interface 500 seen in FIG. 11 includes an environment submenu display 520, which may include light spectrum information 522. Within the light overview interface 524 seen in FIG. 11, a display 526 is provided showing specific operational details of a set of lights 28, i.e., a grid, that is established within a grow room 104. In some embodiments, further details regarding one or more specific lights can readily be accessed through the interface, such as by user-selection. As also seen in FIG. 11, the exemplary user interface 500 may include a navigation dashboard 502, by which the user USR, can readily navigate to view specific detailed interfaces, such as an alerts interface 504, an overview interface 506, a spectrums interface 508, a recipes interface 520, a devices interface 512, a data access interface 514, a sites interface 516, and a settings interface 518.

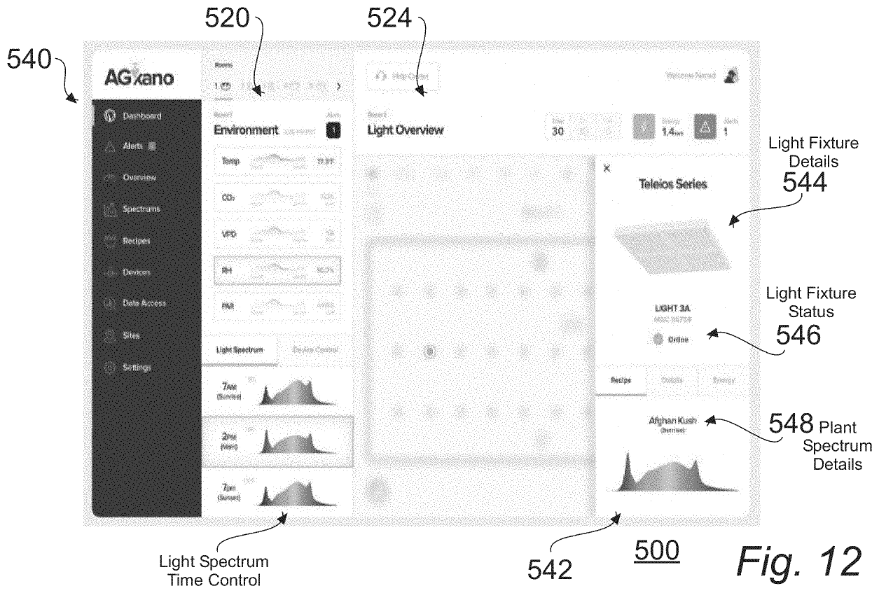

FIG. 12 shows an exemplary user interface 540, showing details associated with an illustrative growing environment 520 and light overview 524, as well as specific details 542 corresponding to one or more light fixtures 28, such as to provide light fixture details 544, light fixture status 546, and plant spectrum details 548 for which a designated light 28 is currently used.

While some of the specific interfaces described herein can be used to display system information on a computer 52 or a tablet 54 having a large display, some embodiments of the system 10 include user interfaces that are uniquely adapted to smaller wireless devices 54, such as a mobile phone 54. While such interfaces can be used to display similar information to that displayed on larger devices 52 and 54, some of the user interfaces and associated applications used for smaller wireless devices 54 may be optimized for in situ tasks to be carried out by personnel within the facility 102, such as while using a mobile phone 54.

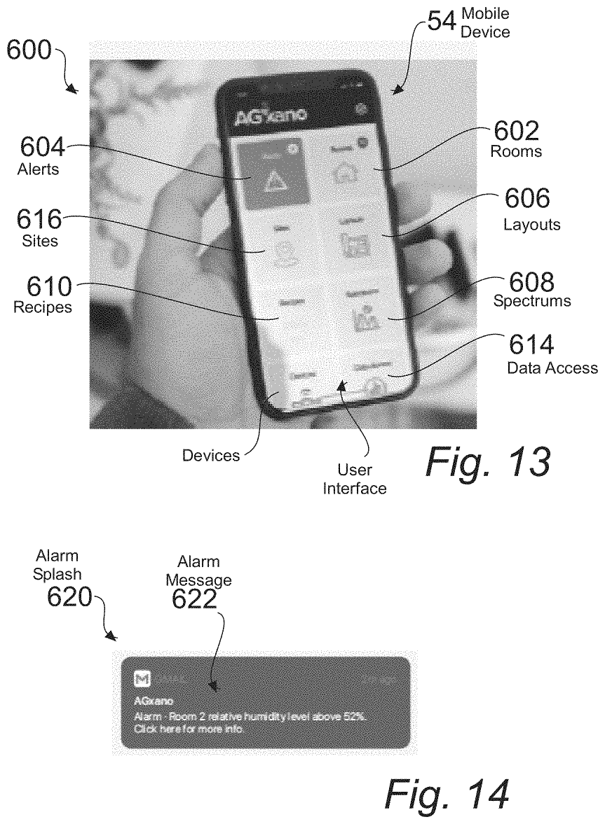

FIG. 13 shows an exemplary system user interface 600 associated with a wireless device 54. FIG. 14 shows an exemplary automated text-based system alarm 620 for a wireless device 54. As seen in FIG. 13, the user interface 600 may display or provide navigation to different operating information for a grow system 10, such as including any of room information 602, alerts information 604, layouts information 606, spectrums information 608, recipes information 610, data access information 614, and sites information 616. As seen in FIG. 14, the system 10 may provide a specific alarm message 622, such as within a notification window 620, by which a user can readily be notified of an alarm condition through a mobile device 54 that is in communication with the system 10. In some embodiments, the alarm message 622 may include an active link by which the user USR may readily access further details regarding the alarm, and/or may wirelessly access the system 10 to take action in response to the alarm. In some embodiments, the system alarm states may be addressed automatically, e.g., through self-healing. In some system embodiments, one or more users USR may be assigned to address specific system alarms, such as for alarms that need to be manually cleared.

FIG. 15 shows an exemplary system user interface 640 associated with a wireless tablet 54. As seen in FIG. 15, a user USR may readily access the environmental data user interface 642, such as to view historical data associated with one or more environmental parameters 644, and may also view specific values, such as detailed information and/or alarms associated with one or more environmental parameters 644.

As seen in the exemplary user interfaces shown in FIGS. 10-14, the user USR may readily be provided with advanced oversight over all aspects of the infrastructure associated with a facility 102 and grow rooms 104, and may have full access to detailed monitoring, analysis, and control over their grows. For instance, in some system embodiments, some or all of the real time and historical data can be tracked throughout the plant production process, and can be accessed and clearly displayed though the user interface. As well, some embodiments of the user interfaces provide the ability to quickly search, sort, and filter the data with regard to one or more customizable parameters. Furthermore, some embodiments of the user interface may allow the user USR to customize how their information is presented, and the intervals by which the data is collected, and/or displayed.

As such, some embodiments of the system 10 provide a user-friendly user interface that provides robust capabilities, so that the user USR can readily access their information and oversee all aspects of their facility 102. Switching between monitoring room conditions, controlling grow conditions, and analyzing previous harvests is made easy. The system user interface allows the grower USR to manage all aspects of plant production, i.e., from the macro to the micro. Some embodiments of the user interface may be configured for managing multiple grow facilities 102 and grow rooms 104, and some embodiments may be configured for tracking individual sensors. Some embodiments of the user interface may allow the user USR to easily toggle or scale their frame of reference. As well, some embodiments of the user interface may allow the user USR to readily access and automatically display key performance indicators (KPIs) for their plant production facility 102.

In some embodiments, the user interface and related applications may provide over the air (OTA) updates. As well, some embodiments, the user interface and related applications may be enabled with encryption, e.g., 256-bit encryption, and may require one or more levels of user permissions or password protection.

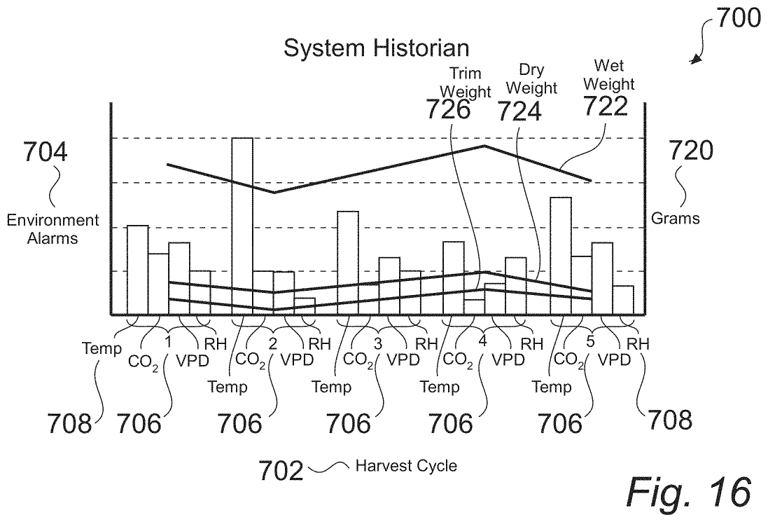

Some embodiments of the system are configured to provide actionable insights that can help the user stay ahead. For example, some embodiments may allow the user USR to evaluate their grow performance and/or effectiveness, and discover where their grow can be improved. In some embodiments, the grow data platform 12 may be configured as an open system platform that provides growers with a foundation to continuously improve on each cycle, such as by integrating heuristic information from past grows. For example, in some embodiments, the user USR can evaluate historical data of their previous cycles, to make adjustments to current and/or future grows that maximize can maximize their returns. For instance, some embodiments of the grow data platform may include a built-in historian and insights engine 700, such as seen in FIG. 16, that can help the grower USR to fine tune their recipes, for healthier plants and larger yields.

FIG. 16 shows an exemplary reporting interface 700 showing the effect of crop yields as a function of alarm reporting over a plurality of harvest cycles 706. For instance, the exemplary reporting interface 700 seen in FIG. 16 can display one or more bar charts 708 associated with a count of alarms 704 for monitored environmental data 708, which can be tracked and displayed for a one or more harvest cycles 706 of a set of harvest cycles 702. In FIG. 16, the exemplary reporting interface 700 can display alarm values for different environmental data 708, such as for any of temperature, carbon dioxide (CO₂), vapor pressure deficit (VPD), and relative humidity (RH) 708.

The exemplary reporting interface 700 seen in FIG. 16 can also display measured yields for a set 702 of harvest cycles 706, such as to display the production level with respect to a normalized value (e.g., grams per watt) for wet weight 722, dry weight 724, and trim weight 726.

In some embodiments of the reporting interface 700, one or more aspects of the data to be displayed may be a chronological set 702 of harvest cycles. In this manner, a grower USR may readily access and analyze how the monitored environmental factors and alarms may be related to the yield and/or quality of crops, and can base decisions for current or future grows based on this wisdom.

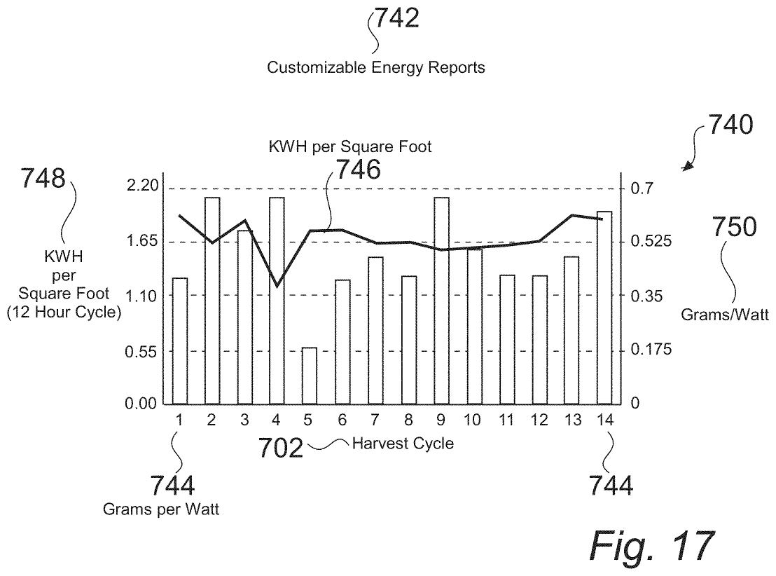

FIG. 17 shows an exemplary reporting interface 740 showing the relationship between energy consumption 748 and crop yield 746 over a set 702 of harvests. For instance, chart 746 shows the energy consumption per square foot (e.g., KWH per sq. ft. for a 12 hour light cycle) 748 for a set 702 of harvest cycles, and also shows values of crop yields 744 (such as based on grams per watt) 750 for the chronological set 702 of harvest cycles. In this manner, a grower can readily access and analyze the relative relationships between harvest yields and energy consumption. In some embodiments of the reporting interface 740 can be customized to access and analyze the energy efficiency of their grows, such as in relation to yield, quality, current pricing, and/or profit, and can base decisions for current or future grows based on this wisdom. Such data can also be used to determine the efficacy of future capital purchases, such as for lighting, monitoring, HVAC, or fertigation systems.

In some embodiments, there may be (e.g., within a graphical or other type of interface (GUI, UI, etc.)), some user inputs that provide different functionality for users to manage the growing process. For instance, the user may be able to provide user inputs such as notes that can be associated with batches, rooms, harvests, etc. For instance, notes can be such observations such as, for instance like “yellowing of leaves,” “stretching,” “bleaching,” “mold,” or any other observation. Further, the user interface may predict and update a list to include potential observations. Also, in some embodiments, the user interface reviews user input data and sanitizes the data for analysis. Further, the interface may permit users to upload images of plants and may perform machine learning or other AI processes on the images for analysis (e.g., to provide recommendations on optimal growing conditions). As information is uploaded from users, the system may timestamp data and associate the data with specific batches.

In some embodiments, the system may record user's operations and treatments as they apply them to rooms, plants, batches, harvests, etc. For example, operations that users can perform may be, for example, operations such as “pruning,” “trellising,” “visual inspection,” “light check,” etc. in some embodiments, the user interface may predict and update the operations list to include some recommended observations. In some implementations, the user interface is designed to sanitize user input data for analysis. Also, the interface may permit users to upload images associated with operations for processing and analysis (e.g., machine learning algorithms). Further, as information is uploaded from users, the system may timestamp data and associate the data with specific batches.

In some embodiments, the system permits users to sign notes, operations, tasks and other elements to other users so that they may complete and track their progress. Other management capability may be provided such as reporting a summary of what is been observed and completed at certain time intervals associated with a particular grow. Further, the system may produce a report card during grows and at the end of each girl to enhance management of the grow. Other interfaces may be provided that allow the user to view and manage information associated with a particular grow or series of grows.

Appendices A-P of provisional Application Ser. No. 63/270,809 show various features of some embodiments of the present invention. For example, Appendix A shows various interfaces for systems according to some embodiments that permit users to manage and view data associated with each grow. Appendix B shows an example AGxano Full Product Brochure showing various embodiments. Appendix C shows an example KPI Presentation that shows various embodiments. Appendix D shows example wireless node procedures according to various embodiments. Appendix E shows an example white paper according to various embodiments. Appendices F-P show additional possible components and embodiments.

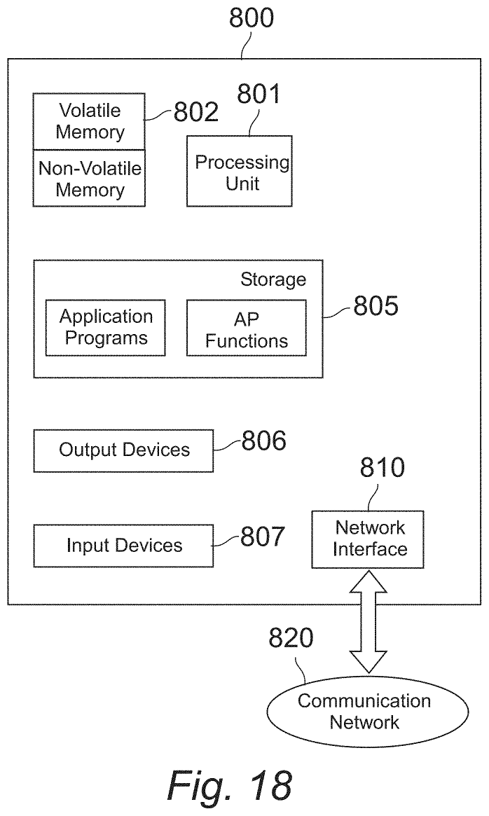

FIG. 18 shows, schematically, an illustrative computer 800 on which any aspect of the present disclosure may be implemented. In the embodiment shown in FIG. 18, the computer 800 includes a processing unit 801 having one or more processors and a non-transitory computer-readable storage medium 802 that may include, for example, volatile and/or non-volatile memory. The memory 802 may store one or more instructions to program the processing unit 801 to perform any of the functions described herein. The computer 800 may also include other types of non-transitory computer-readable medium, such as storage 805 (e.g., one or more disk drives) in addition to the system memory 802. The storage 805 may also store one or more application programs and/or resources used by application programs (e.g., software libraries), which may be loaded into the memory 802.

The computer 800 may have one or more input devices and/or output devices, such as devices 806 and 807 illustrated in FIG. 17. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 807 may include a microphone for capturing audio signals, and the output devices 806 may include a display screen for visually rendering, and/or a speaker for audibly rendering, recognized text. As another example, the input devices 807 may include sensors (e.g., 36, 37, 38, or a sensor within sensor hub 32), and the output devices 806 may include a device configured to interpret and/or render signals collected by the sensors (e.g., a sensor hub).

As shown in FIG. 17, the computer 800 may also comprise one or more network interfaces (e.g., the network interface 810) to enable communication via various networks (e.g., the network 820). Examples of networks include a local area network or a wide area network, such as an enterprise network or the Internet. Such networks may be based on any suitable technology and may operate according to any suitable protocol and may include wireless networks, wired networks or fiber optic networks. Such networks may include analog and/or digital networks.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the present disclosure. Further, though advantages of the concepts described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Also, the various methods or processes outlined herein may be coded as software that is executable on one or more processors that employ any one of a variety of operating systems or platforms. However, it should be appreciated that aspects of the present disclosure are not limited to using an operating system. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure described above. The computer-readable medium or media may be transportable, such that the program or programs stored thereon can be loaded onto one or more different computers or other processors to implement various aspects of the present disclosure as described above.

The terms “program” or “software” are used herein to refer to any type of computer code or set of computer-executable instructions that can be employed to program a computer or other processor to implement various aspects of the present disclosure as described above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the concepts disclosed herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which one or more examples has been provided, including, for example, with reference to FIGS. 5-9. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “grower” of a “user.” It should be appreciated that a “grower” or a “user” need not be a single individual, and that in some embodiments, actions attributable to a “grower” of a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within .+−0.20% of a target value in some embodiments, within .+−0.10% of a target value in some embodiments, within .+−0.5% of a target value in some embodiments, within .+−0.2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A method for growing plants, comprising:
controlling operation of a lighting system on a lighting schedule to mimic a circadian rhythm for cultivation of one or more first plants;
gathering results of a harvest of the one or more first plants; and
based on the results of the harvest of the one or more first plants, modifying operation of the lighting system to change the circadian rhythm for the cultivation of one or more second plants, wherein the one or more second plants are similar to the one or more first plants.

2. The method of claim 1, wherein the lighting system comprises a light emitting diode (LED) light system.

3. The method of claim 2, wherein the LED light system includes colored LEDs.

4. The method of claim 2, wherein the LED light system includes white LEDs.

5. The method of claim 1, wherein the lighting system includes a light system driver.

6. The method of claim 5, wherein the light system driver is DALI-2 compliant.

7. The method of claim 1, wherein the circadian rhythm is matched to the Sun.

8. The method of claim 1, wherein the circadian rhythm is matched to the plant.

9. The method of claim 1, further comprising:
modifying a light spectrum of the lighting system.

10. The method of claim 9, wherein the modifying of the light spectrum includes modifying the light spectrum during the morning of the light schedule.

11. The method of claim 10, wherein modifying the light spectrum includes adding more reds to the light spectrum in the morning.

12. The method of claim 9, wherein the modifying of the light spectrum includes modifying the light spectrum in the evening of the light schedule.

13. The method of claim 12, wherein modifying the light spectrum includes adding more blues to the light spectrum in the evening.

14. The method of claim 1, wherein the lighting system comprises one or more light fixtures and one or more light sensors, the method further comprising:
using at least one of the light sensors to measure the amount of light emitted from at least one of the light fixtures; and
adjusting the brightness of the at least one light fixture based on the measured light to meet a desired intensity.

15. The method of claim 14, further comprising:
using the at least one light sensor to physically verify that the lighting system is turned on at a predetermined time.

16. The method of claim 1, wherein the lighting system comprises one or more light fixtures and one or more light sensors in a greenhouse, the method further comprising:
using at least one of the light sensors in a greenhouse to measure an amount of light received by at least one of the one or more first plants or the one or more second plants from sunlight; and
adjusting an intensity of the lighting system, based on the measured light, to meet a predetermined amount of light.

17. The method of claim 1, further comprising:
wirelessly controlling the lighting system to adjust an intensity of light emitted by the lighting system, as at least one of the one or more first plants or the one or more second plants grows taller, to maintain a constant amount of light at a canopy of the at least one plant.

18. A lighting system, comprising:
a lighting fixture having a controllable output intensity; and
a driver connected to the lighting fixture configured to operate the lighting fixture on a lighting schedule to mimic a circadian rhythm for cultivation of a plant, and further configured to modify operation of the lighting fixture to change the circadian rhythm for the cultivation of the plant, based on results of a prior harvest for a similar plant.

19. The lighting system of claim 18, wherein the lighting fixture comprises a light emitting diode (LED) light fixture.

20. The lighting system of claim 19, wherein the LED light fixture includes colored LEDs.

21.-72. (canceled)
